(19) United States
(12) Patent Application Publication
(10) Pub. No.: US 2025/0170885 A1
(43) Pub. Date: May 29, 2025

(54) RADIATOR MODULE OF A MOTOR VEHICLE

(71) Applicant: Brose Fahrzeugteile SE & Co. Kommanditgesellschaft, Wuerzburg, Wuerzburg (DE)

(72) Inventors: Anand PATEL, Oldenburg (DE); Lutz WULF, Jade (DE)

(73) Assignee: Brose Fahrzeugteile SE & Co. Kommanditgesellschaft, Wuerzburg, Wuerzburg (DE)

(21) Appl. No.: 19/039,528

(22) Filed: Jan. 28, 2025

Related U.S. Application Data
(63) Continuation of application No. PCT/EP2023/070096, filed on Jul. 20, 2023.

(30) Foreign Application Priority Data
Jul. 28, 2022 (DE) 10 2022 207 780.6

(51) Int. Cl. B60K 11/04; F28F 19/00

(52) U.S. Cl. CPC B60K 11/04; F28F 19/002; F28F 2225/04

(57) ABSTRACT

A radiator module of a motor vehicle, comprising a radiator that includes two water tanks between which a radiator mesh structure is located. The radiator module has a reinforcing assembly connected to the radiator for absorbing and/or diverting forces during a crash. A region of a motor vehicle is also provided.

This nonprovisional application is a continuation of International Application No. PCT/EP2023/070096, which was filed on Jul. 20, 2023, and which claims priority to German Patent Application No. 10 2022 207 780.6, which was filed in Germany on Jul. 28, 2022, and which are both herein incorporated by reference.

### BACKGROUND OF THE INVENTION

### Field of the Invention

The invention relates to a radiator module of a motor vehicle. The radiator module includes a radiator having two water tanks and having a radiator mesh structure. The invention further relates to a region of a motor vehicle.

### Description of the Background Art

Motor vehicles which include an internal combustion engine have a considerable heat development during operation. To maintain the operating temperature of the internal combustion engine, a coolant is used, which, in turn, must be cooled. If the motor vehicle includes an electric motor for propulsion, a high-voltage energy accumulator is charged and discharged during operation, heat losses also occurring here, so that the high-voltage energy accumulator must be cooled. A refrigerant is commonly used for cooling and also for operating an air-conditioning system, which also heats up during operation. To cool the coolant/refrigerant again, a radiator which is struck by an airstream is commonly used. It is arranged, for example, in a central location behind a front bumper of the motor vehicle, so that a volume flow of the airstream is increased. After passing through the radiator, the air is guided, for example, under the motor vehicle or over the motor vehicle in the region of a windshield.

To improve the aerodynamic shape, the air is introduced into wheel housings to an increasing extent. As a result, it is also possible to attach the radiator there. A design flexibility is increased thereby. This also results in a shifting of the center of gravity of the motor vehicle, whereby vehicle dynamics are improved. A maintenance is also simplified in this way, and it is possible to increase the total number of radiators used.

In the case that the motor vehicle strikes a solid obstacle, a vehicle body as well as attachments of the motor vehicle are deformed. During a front-end collision of the motor vehicle, a penetration is possible due to the comparatively short distance from the front wheels to a footwell of the passenger compartment (passenger cell), which may result in comparatively serious injuries to the occupants of the passenger compartment.

A wheel adjustment element is known from DE 10 2019 124 581 A1, which has a form element. It is provided for the purpose of guiding the wheel outwardly in the direction of a door sill of the vehicle in the event of an accident or to reduce the impact energy of the accident. It is necessary to provide an additional installation space, for which reason a design flexibility for construction is reduced. An additional structural element must also be mounted in this way, for which reason manufacturing costs and also an assembly time are increased.

### SUMMARY OF THE INVENTION

It is therefore an object of the invention to provide a particularly suitable radiator module of a motor vehicle and a particularly suitable region of a motor vehicle, a safety for occupants of the motor vehicle, in particular, being increased, and a mounting being advantageously simplified and/or manufacturing costs being reduced.

The radiator module is a constituent part of a motor vehicle. The radiator module is thus suitable, in particular provided and configured, to be mounted on further structural elements of the motor vehicle. The motor vehicle is suitably land-based and is, for example, a passenger car. The motor vehicle is alternatively a commercial vehicle, for example a truck or a bus.

In the mounted state, the radiator module is used, in particular, to cool a fluid which is conducted through the radiator module during operation. The fluid may be, for example, a coolant, such as a cooling liquid, or a refrigerant. The radiator module is thus a part of a coolant circuit or a refrigerant circuit. For example, an internal combustion engine of the motor vehicle is cooled with the aid of the coolant. If the radiator module is a constituent part of the refrigerant circuit, the radiator module is used, in particular, to cool energy accumulators of the motor vehicle, preferably batteries. Alternatively, a temperature control of an interior of the motor vehicle takes place with the aid of the radiator module. The refrigerant circuit preferably includes in each case an evaporator and/or a compressor.

The radiator module comprises a radiator, which comprises two water tanks. The water tanks are each advantageously provided with a box-shaped design, and a spatial volume is thus surrounded with the aid thereof, within which, in particular, the particular fluid is situated during operation. At least one of the water tanks suitably has an inlet and/or an outlet for the fluid. The water tanks are advantageously made from an aluminum and/or are elongated.

A radiator mesh structure is arranged between the water tanks, which is suitably fastened to the water tanks. The radiator mesh structure has, in particular, a grid structure, such as a honeycomb structure, through which multiple tubes or other conduits are laid, which are thermally contacted within the grid structure. The two water tanks are fluidically connected with the aid of the tubes or conduits, so that the fluid is moved through the radiator mesh structure during operation. A surface of the radiator mesh structure is enlarged due to the grid structure, which makes a heat removal easier. During the operation of the motor vehicle, an airstream or another wind flows through the radiator mesh structure, so that a cooling or at least temperature equalization of the fluid situated in the tubes takes place with the ambient temperature. In particular, the radiator mesh structure or at least the possible grid structure is made from a thermally conductive material, preferably a metal. In particular, the radiator mesh structure or at least the possible grid structure is manufactured from an aluminum, for which reason manufacturing costs and a weight of the radiator are reduced.

The radiator module further comprises a reinforcing assembly, which is connected to the radiator. The reinforcing assembly is used to absorb and/or divert forces during an accident. The reinforcing assembly is suitable, in particular provided and configured, for this purpose. During an accident, in particular during a collision of the motor vehicle with an obstacle, advantageously during a front-end collision of the motor vehicle, forces acting thereupon are consequently absorbed/diverted with the aid of the reinforcing assembly. For example, the forces are thus only passed on in a reduced manner with the aid of the reinforcing assembly, a deformation of a further structural element, for example, being induced with the aid of the reinforcing assembly, so that a portion of the forces/energy is absorbed there. Alternatively or combined therewith, the diversion of the forces takes place in such a way that a direction in which the forces act is changed. For example, a force applied/acting only at a single point during an accident is spread over a larger surface area with the aid of the reinforcing assembly, in particular the surface area of the radiator, so that, while the energy continues to be present, it is distributed to an enlarged surface area, so that, for example, multiple further structural elements/components of the motor vehicle are plastically deformed and thus absorb the energy.

In particular, forces acting in the direction of a passenger compartment (passenger cell) during the accident are thus at least partially absorbed and/or diverted due to the reinforcing assembly, for which purpose the reinforcing assembly is, in particular, suitable, preferably provided and configured. A penetration of structural elements into the passenger compartment, which is also referred to as the passenger cabin or passenger cell, in particular a footwell thereof, is thus avoided and/or at least a deformation of the passenger cell is reduced, for which reason a safety for occupants of the motor vehicle is increased. Since the reinforcing assembly is fastened to the radiator, it is possible to prefabricate the radiator module and mount it in one work step on the other part of the motor vehicle. A mounting time is thus reduced. In other words, it is not necessary to attach the reinforcing assembly to the motor vehicle separately. It is also not necessary to provide additional mounting elements for the reinforcing assembly on the motor vehicle, for which reason a space requirement and also manufacturing costs are reduced.

For example, the reinforcing assembly comprises a plate, with the aid of which the entire radiator is covered. A safety is further increased in this manner. However, the reinforcing assembly particularly preferably comprises a reinforcing brace, which is fastened to the water tanks. Material and manufacturing costs are reduced due to the reinforcing brace. A weight of the radiator module is also reduced. In particular, the reinforcing brace runs in parallel to and/or along the radiator mesh structure. An airflow through the radiator mesh structure is not hindered, or only to a limited extent, with the aid of the reinforcing brace, for which reason a cooling effect of the radiator module is not or is only slightly restricted.

For example, the reinforcing brace can be fastened to the radiator mesh structure or, particularly preferably, separately therefrom. A slight relative movement of the reinforcing brace in relation to the radiator mesh structure is thus also possible, for example during a movement of the motor vehicle along a bad stretch of road. A connection between the reinforcing brace and the radiator mesh structure is not stressed, which could otherwise result in a damage to the radiator mesh structure. In addition, due to the fastening of the reinforcing brace to the water tanks, the latter are stabilized relative to each other, and they are thus not fastened to each other only with the aid of the radiator mesh structure. As a result, a robustness of the radiator itself is increased. Due to the water tanks, a stable fastening of the reinforcing brace to the radiator is also given. For example, the reinforcing brace is glued or screwed to the water tanks. However, the reinforcing brace is particularly preferably welded to the water tanks, for which reason a stability is increased.

The reinforcing brace can be particularly preferably made from a comparatively stable material, which has, in particular, a comparatively high modulus of elasticity. The reinforcing assembly therefore remains at least partially intact even during comparatively strong acting forces, for which reason a functional reliability is ensured even during a serious accident. In particular, the material of the reinforcing assembly, or at least the reinforcing brace, has a comparatively low brittleness, for which reason a breakage thereof is ruled out during use. Even in the case of a comparatively high stress, the water tanks are thus stabilized in relation to each other, and the acting forces are, in particular, comparatively safely absorbed/diverted. The reinforcing brace is particularly preferably manufactured from a steel, such as V2A steel, or advantageously from a titanium, for example titanium or a titanium alloy. A stability is thus further increased, and a functionality is ensured even in adverse circumstances.

For example, the reinforcing brace can be made from solid material. However, the reinforcing brace is particularly preferably a U-profile strip. A safety, a weight, and the amount of material used are thus reduced, a comparatively high stability nevertheless prevailing. Due to the U profile, the cross-section of the reinforcing brace has two legs in parallel to each other. For example, these are arranged in parallel to the radiator mesh structure. However, they are particularly preferably arranged perpendicularly to the radiator mesh structure. A comparatively high stability is thus provided with the aid of the reinforcing brace when forces strike perpendicularly to the radiator mesh structure, so that the radiator mesh structure is also protected with the aid of the reinforcing brace. In other words, a bending of the radiator mesh structure is prevented with the aid of the reinforcing brace.

The free ends of the parallel legs advantageously face away from the radiator mesh structure, and the leg perpendicular to the parallel legs is offset in the direction of the radiator mesh structure and, for example, lies adjacent thereto. A comparatively flat structure of the radiator module is thus implemented, and it is possible, for example, to arrange further structural elements between the parallel legs. Existing installation space is thus used efficiently.

For example, the edges of the walls of the U-profile strip resulting due to the parallel legs are designed to be straight. In other words, the cross-section of the U-profile strip is the same along the entire length of the reinforcing brace. This makes it easier to manufacture the reinforcing brace. Alternatively, one or both edges is/are, for example, corrugated and/or partially brought out. With the aid of the shape of the edges, further structural elements of the motor vehicle pushed onto the reinforcing brace during an accident are suitably moved along, i.e. in a desired direction, preferably away from the possible passenger compartment. The absorption and diversion of forces are thus improved.

For example, only a single reinforcing brace of this type is present. A weight as well as material costs are thus comparatively low. However, the reinforcing assembly particularly preferably comprises multiple reinforcing braces of this type. The requirements of each of the individual reinforcing braces are thus reduced, and they may be designed to be comparatively cost-effective and compact. In particular, the reinforcing braces are arranged in parallel to each other, for which reason a manufacturing is made easier. The reinforcing braces are preferably of the same design, so that equivalent parts may be used.

For example, the reinforcing assembly is made up only of the one or more reinforcing brace(s). In one refinement, a stabilizing brace or further structural elements are additionally present. The reinforcing braces are connected to each other with the aid of the stabilizing brace, and the stabilizing brace runs, for example, perpendicularly to one or all of the reinforcing braces. A stabilization of the reinforcing braces with respect to each other thus takes place with the aid of the stabilizing brace, so that a robustness is further increased. For example, a force acting upon only one of the reinforcing braces is transferred with the aid of the stabilizing brace to the remaining reinforcing braces, so that a stability and robustness are increased. In particular, the stabilizing brace is a U-profile strip or another profile strip. A stability is thus increased, and a weight is reduced. For example, the reinforcing assembly comprises only the stabilizing brace or particularly preferably multiple stabilizing braces of this type, so that a robustness is further increased.

For example, a radiator module may be formed only with the aid of the radiator and the reinforcing assembly. However, the radiator module particularly preferably additionally comprises an electromotive fan. The latter includes an electric motor and an impeller driven thereby. In particular, the impeller is an axial impeller, so that air is moved along its rotation axis during the operation of the impeller. The electric motor is, for example, a brush-type commutator motor or particularly preferably a brushless DC motor (BLDC). In particular, the electromotive fan is arranged in such a way that air is sucked or blown through the radiator mesh structure during operation, depending on the rotational direction of the impeller. In this way, it is possible to amplify or establish an air flow through the radiator mesh structure, in particular, if no airstream is present, for example, when the motor vehicle is at a standstill.

The radiator module advantageously comprises a frame, with the aid of which the radiator mesh structure is at least partially covered. The frame has an opening, within which the impeller is preferably arranged. The electric motor is suitably fastened to the frame, so that a stability is increased. Air flowing through the radiator mesh structure is deflected with the aid of the frame, and the formation of an air leakage during the operation of the electromotive fan is avoided, which would result in a reduction in efficiency. For example, the frame also comprises a back-pressure valve, so that a cooling capacity is improved at comparatively high travel velocities of the motor vehicle.

The region is a part of the motor vehicle, which is, for example, a commercial vehicle such as a truck or bus, or particular preferably a passenger car. The motor vehicle is advantageously land-based. The region comprises a wheel housing. A wheel is situated within the wheel housing. The region additionally comprises, for example, a suspension, with the aid of which the position of the wheel is stabilized within the wheel housing, or the suspension is separate herefrom. During the locomotion of the motor vehicle, the wheel is rotated within the wheel housing, the wheel advantageously being spaced apart from a boundary of the wheel housing. In particular, the wheel is a front wheel of the motor vehicle, and the wheel housing is thus the or one of the front wheel housing(s) of the motor vehicle. The wheel housing is thus situated in front of a passenger compartment in a vehicle direction in front of the vehicle, within which, for example, occupants, i.e. people, are located during the operation of the vehicle. The vehicle direction corresponds to a direction of travel, which is, in particular, in parallel to the longitudinal direction of the motor vehicle. The direction of travel is the direction of the motor vehicle in which the motor vehicle is primarily moved and is provided herefor, unless a change of direction takes place. In particular, the line of sight of the driver, or at least an arrangement of a driver's seat of the motor vehicle, is oriented in the direction of travel.

The region also includes a radiator module. The radiator module comprises a radiator having two water tanks, between which a radiator mesh structure is arranged. The radiator module further comprises a reinforcing assembly connected to the radiator for absorbing and/or diverting forces during an accident. The reinforcing assembly is suitable, in particular provided and configured, for this purpose. For example, a liner is arranged between the wheel and the radiator module, or these are arranged, for example, directly adjacent to each other, a mechanical contact between the wheel and the radiator module preferably being prevented during normal operation.

Due to the radiator module, forces acting upon the wheel, which, in the absence of the radiator module, would be pushed into the passenger compartment during an accident due to the forces, are at least partially absorbed and diverted, so that a penetration of the wheel into the passenger compartment is, for example, completely prevented. However, a force and/or a speed at which the wheel moves into the passenger compartment or is pressed against the boundary thereof is at least decreased, so that a deformation of the passenger cell is reduced. A safety for people (occupants) situated in the passenger compartment is thus increased. In particular, a footwell of the passenger compartment (passenger cell) is at least partially protected with the aid of the reinforcing assembly.

The reinforcing assembly is advantageously designed in such a way that the wheel is at least partially moved out of the wheel housing during an accident. In other words, the forces acting during the accident are correspondingly absorbed and/or diverted with the aid of the reinforcing assembly, so that the wheel is at least partially moved out of the wheel housing. For example a force is applied to the wheel with the aid of the reinforcing assembly, due to which the wheel is moved outwardly away from the body of the motor vehicle and thus away from the passenger cell. In other words, the reinforcing assembly thus acts as a wheel adjustment element. In summary, a force acting in parallel to the direction of locomotion is, for example, at least partially diverted during an accident, in particular a front-end collision of the motor vehicle, with the aid of the reinforcing assembly, so that a force acts upon the wheel which also has a component perpendicular to the direction of locomotion.

For example, the radiator module can be arranged behind the wheel in a direction of travel. The radiator module is thus situated between the wheel and the passenger compartment. The wheel is therefore deflected, in particular, with the aid of the reinforcing assembly, so that it does not penetrate the passenger compartment. However, the radiator module is particularly preferably arranged in front of the wheel in the direction of travel. The radiator module is thus pressed onto the wheel during a front-end collision. Due to the design of the reinforcing assembly, in particular, the forces applied to the wheel with the aid of the radiator module are such that the wheel is moved out of the wheel housing, i.e., in particular, away from the body of the motor vehicle. Due to this arrangement, the radiator module is the first structural element to act upon the wheel during the accident, so that a comparatively precise determination of the direction of the force applied to the wheel is possible with the aid thereof, so that the latter may be guided/pressed away from the passenger cell. Due to the comparatively wide-area design of the radiator module, the direction of the applied force is always essentially the same, even with a slight deformation of the radiator module due to the accident, and a comparatively great transfer of force is possible. A safety is thus further increased.

By arranging the radiator module in this manner, small pieces of material stirred up by the wheel during a locomotion of the motor vehicle are furthermore not directed onto the radiator module and therefore also not onto the radiator. A damage to the radiator mesh structure is thus avoided, and it is not necessary to design it to be comparatively robust and therefore heavy.

For example, the reinforcing assembly is arranged behind the radiator in the direction of travel. The radiator is thus at least partially protected against the wheel with the aid of the reinforcing assembly, for example, during a comparatively extensive steering of the wheel or a manual wheel change. During the accident and therefore a displacement of the radiator module in the direction of the wheel, the reinforcing assembly is first in contact with the wheel, so that the latter is deformed in a targeted manner, for example due to the design of the reinforcing assembly. However, the reinforcing assembly is particularly preferably arranged in front of the radiator in the direction of travel. In a comparatively minor accident, such as trivial damage while parked, when the speed at which the impact takes place is comparatively low, the radiator is protected with the aid of the reinforcing assembly, so that a damage to the radiator is avoided. As a result, it is not necessary to replace the radiator module to restore the motor vehicle, for which reason the repair costs are reduced. In this way, the motor vehicle also continues to be operational, so that it may still be moved, for example, to a repair shop.

The invention further relates to a motor vehicle having a region of this type. The motor vehicle preferably has multiple regions of this type and thus multiple wheel housings, within each of which a corresponding radiator may be arranged.

The advantages and refinements specified in connection with the impeller are to be similarly transferred to the region/motor vehicle as well as to each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a motor vehicle having a region which comprises a radiator module;

FIGS. 2, 3 show a radiator of the radiator module, to which a reinforcing assembly is connected, in a perspective view and a top view, respectively;

FIG. 4 shows a perspective view of a reinforcing brace of the reinforcing assembly; and

FIG. 5 shows a perspective view of an example of the radiator.

### DETAILED DESCRIPTION

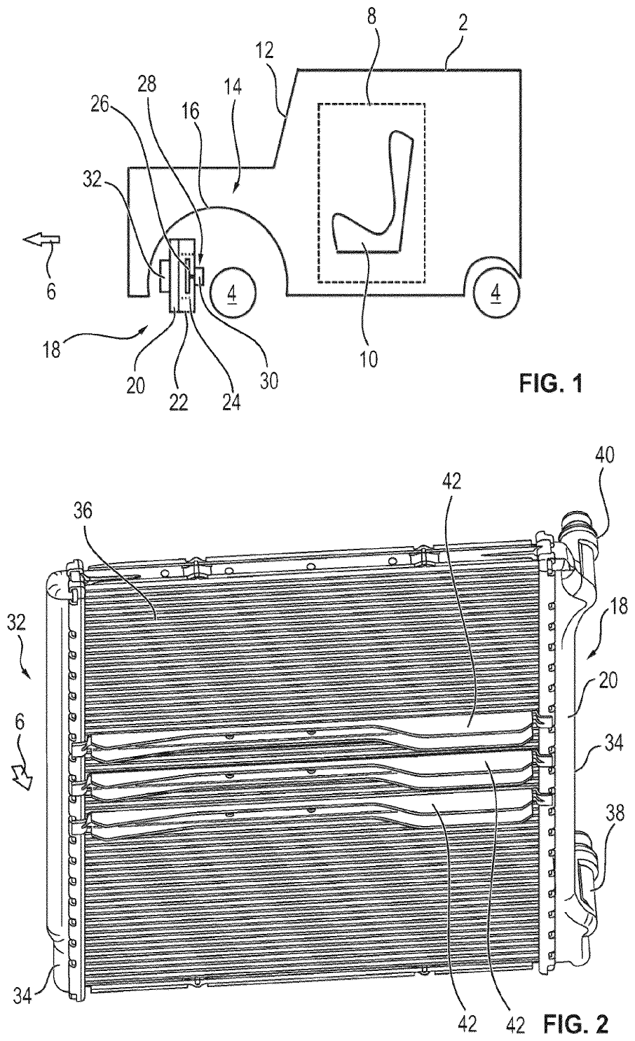

FIG. 1 schematically shows a motor vehicle 2 in the form of a passenger car, which has four wheels 4. Two of wheels 4 are front wheels and the other two are rear wheels of motor vehicle 2. In other words, two of wheels 4 are offset in relation to the other two wheels 4 in a direction of travel 6 of motor vehicle 2, which is in parallel to the longitudinal axis of motor vehicle 2 and in which motor vehicle 2 is primarily moved during normal operation. A passenger compartment 8, which is also referred to as a passenger cell or passenger cabin, is situated between the front two of wheels 4 (front wheels) and the other ones. Multiple seats 10 are situated in passenger compartment 8, only one of which is illustrated. Seats 10 serve to accommodate occupants when they use motor vehicle 2 for locomotion. Passenger compartment 8 is surrounded by a vehicle body 12, to which wheels 4 are connected with the aid of a chassis.

One of front wheels 4 is assigned to a region 14 of motor vehicle 2. In other words, region 14 includes one of wheels 4. Region 14 also includes a wheel housing 16, withing which wheel 4 is arranged. Wheel housing 16 is provided with the aid of a cutout of vehicle body 12 and has liners and the like. A radiator module 18 is also arranged within wheel housing 16 in front of wheel 4 in the direction of travel. Radiator module 18 is used to cool a fluid, such as a cooling liquid, and is exposed for this purpose to an airstream during the locomotion of motor vehicle 2, which is guided to wheel housing 16 through a front of vehicle body 12, through the interior of the motor vehicle.

Radiator module 18 includes a radiator 20 of an essentially planar design, with the aid of which the fluid is guided. A frame 22 is connected to radiator 20. In the illustrated example, radiator 20 is arranged essentially perpendicularly to direction of travel 6, and frame 22 is situated between radiator 20 and wheel 4. Frame 22 is made from a plastic and has a central opening 24, within which an impeller 26 of an electromotive fan 28 of radiator module 18 is arranged. Impeller 28 is arranged in parallel to radiator 20 and is driven with the aid of an electric motor 30 of electromotive fan 28. Electric motor 30 is designed as a brushless DC motor (BLDC) and is fastened to frame 22.

A reinforcing assembly 32 of radiator module 18 is connected, namely fastened, to radiator 20 on the side of frame 22 facing away therefrom. Reinforcing assembly 32 is therefore situated in front of radiator 20 in direction of travel 6. To assemble motor vehicle 2, radiator module 18 is first manufactured, which includes radiator 20 and reinforcing assembly 32 fastened thereto, as well as frame 22 fastened thereto and electromotive fan 28 fastened to frame 22. It is possible to manufacture radiator module 18 separately from the other structural elements of motor vehicle 2, which increases a flexibility. Radiator module 18 is mounted as a whole onto the remaining constituent parts of motor vehicle 2, such as vehicle body 12, so that an assembly time is shortened.

During an accident of motor vehicle 2, namely a front-end collision, forces applied by an obstacle act upon a front end of motor vehicle 2. The front end of motor vehicle 2 is deformed and pushed against direction of travel 6, so that the size of wheel housing 16 is reduced. The pushed structural elements of motor vehicle 2, for example vehicle body 16, strike radiator module 18 before the latter is able to strike wheel 4. The pushed structural elements first strike reinforcing assembly 32, via which the forces are diverted onto radiator module 18. Reinforcing assembly 32 is designed in such a way that radiator module 18 is partially tilted due to the prevailing forces and/or pushed onto wheel 4 against direction of travel 6 in such a way that wheel 4 is moved out of wheel housing 16. In summary, the forces acting during the accident are partially absorbed and/or diverted with the aid of radiator module 18, namely the reinforcing assembly, so that a force acts upon wheel 4 which has a component perpendicular to direction of locomotion 6, and on the basis of which wheel 4 is moved out of wheel housing 16 and is thus spaced apart from vehicle body 12.

For example, wheel 4 is completely detached from the other constituent parts of motor vehicle 2 or is only offset laterally. However, it is at least prevented in this way that wheel 4 penetrates passenger compartment 8 due to the prevailing forces and endangers, in particular injures, people situated therein. In summary, reinforcing assembly 22 is used to absorb and divert forces during the accident.

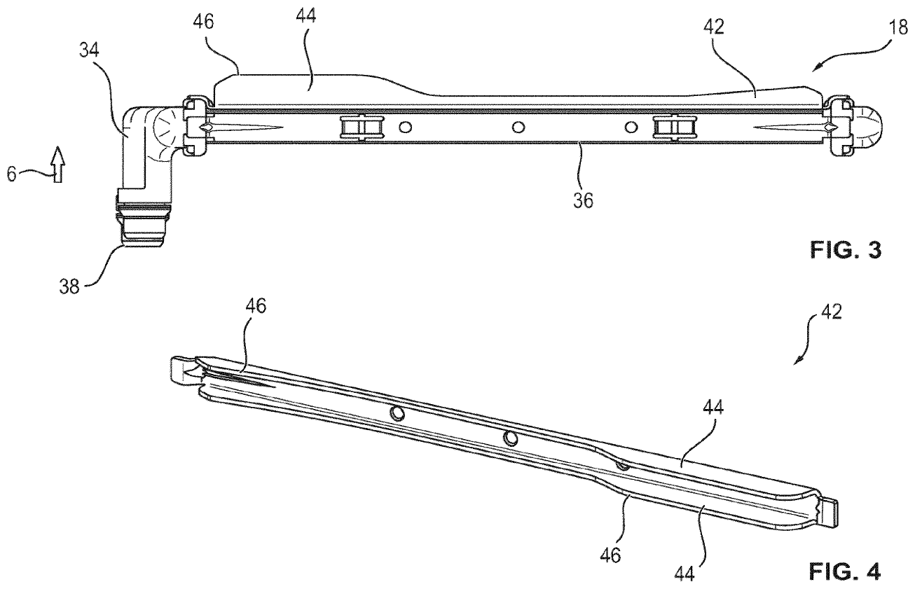

A section of radiator module 18 is illustrated against direction of travel 6 in a perspective view in FIG. 2 and in a top view in FIG. 3, namely radiator 20 as well as reinforcing assembly 32 fastened thereto. Radiator 20 includes two box-shaped water tanks 34, which are manufactured from aluminum and are arranged in an essentially vertical manner in the mounted state. Water tanks 34 are provided with a hollow design, and the cooling fluid is situated therein.

The two water tanks 34 are spaced apart from each other in a horizontal direction, and a radiator mesh structure 36 is situated therebetween, which includes multiple tubes, with the aid of which the two water tanks 34 are fluidically connected. The tubes run essentially in the horizontal direction. The tubes are embedded into a grid structure of radiator mesh structure 36, which is thermally contacted to the tubes. A surface of radiator mesh structure 36 is enlarged due to the grid structure.

During operation, the fluid is introduced into an assigned water tank 34 via an inlet 38 formed on one of water tanks 34 and from there into the other water tank 34 via the tubes as well as back again. This takes place multiple times with the aid of the tubes until the fluid is guided out of radiator 20 via an outlet 40, which is formed on water tank 34 assigned to inlet 38. The heat present in the fluid is output to the grid structure, through which an airstream flows, so that the fluid is cooled.

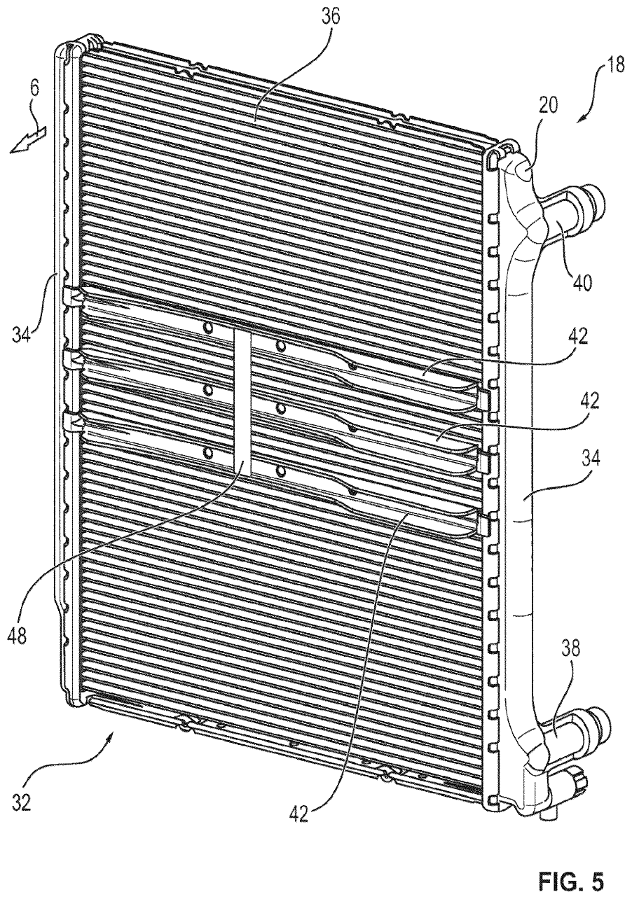

Reinforcing assembly 32 includes a total of three reinforcing braces 42, one of which is illustrated in a perspective view in FIG. 4. Reinforcing braces 42 are of the same design and are each designed as a U-profile strip made from a titanium. The opposite end of each reinforcing brace 42 are each fastened to one of water tanks 34, namely either riveted or welded. Each of reinforcing braces 42 partially covers radiator mesh structure 36, but is not fastened thereto.

The parallel legs resulting as a cross-section from the U-profile each form a wall 44, walls 44, and thus also the legs, being arranged perpendicularly to radiator mesh structure 36. The free ends of the legs, and thus also front edge 46 of each wall 44, are oriented away from radiator mesh structure 36. The two front edges 46 are designed to be congruent to each other and corrugated, for which reason structural elements striking reinforcing assembly 32 are suitably deflected, so that the desired force is applied to wheel 4 with the aid of reinforcing assembly 32.

FIG. 5 shows a perspective view of a modification of radiator module 18, which again includes radiator 20. The dimensions herein are modified, the length of water tanks 34 being enlarged, while they are offset in relation to each other. The dimensions of radiator mesh structure 36 are adapted accordingly. Reinforcing assembly 32 is again present, which comprises the three reinforcing braces 42. Reinforcing braces 42 are also shortened, due to the changed distance between water tanks 34.

In contrast to the previous example, in which reinforcing assembly 32 was formed only with the aid of the three reinforcing braces 42, this one now comprises a stabilizing brace 48. Stabilizing brace 48 is arranged perpendicularly to direction of travel 6 as well as to the course of reinforcing braces 42 and fastened to all three reinforcing braces 42, namely by means of welding. The material of stabilizing brace 48 is the same as the material of reinforcing braces 42, for which reason a fastening thereof to each other is made easier.

On the one hand, reinforcing braces 42 are stabilized in relation to each other with the aid of stabilizing brace 48 during the accident, so that a detachment thereof is prevented even in a comparatively serious accident. On the other hand, a force applied only to one of reinforcing braces 42 is also introduced into remaining stabilizing braces 42 with the aid of stabilizing brace 48, for which reason a robustness is increased. The generation of the force to be applied to wheel 4 is also made easier in this way, so that the latter is moved out of wheel housing 16. It is thus also possible to prefabricate reinforcing assembly 32 before it is mounted in its entirely on radiator 20.

The invention is not limited to the examples described above. Instead, other variants of the invention may be derived herefrom by those skilled in the art without departing from the subject matter of the invention. Moreover, in particular, all individual features described in connection with the individual examples may also be otherwise combined with each other without departing from the subject matter of the invention.

What is claimed is:

1. A radiator module of a motor vehicle, the radiator module comprising:
a radiator that comprises two water tanks;
a radiator mesh structure arranged between the two water tanks; and
a reinforcing assembly connected to the radiator for absorbing and/or diverting forces during an accident.

2. The radiator module according to claim 1, wherein the reinforcing assembly comprises a reinforcing brace, which is fastened to the water tanks.

3. The radiator module according to claim 2, wherein the reinforcing brace is a U-profile strip, and wherein legs situated substantially in parallel to each other being arranged substantially perpendicularly to the radiator mesh structure.

4. The radiator module according to claim 2, wherein the reinforcing assembly comprises multiple reinforcing braces of this type.

5. The radiator module according to claim 4, wherein the reinforcing braces are connected to each other with the aid of a stabilizing brace of the reinforcing assembly.

6. The radiator module according to claim 1, further comprising an electromotive fan.

7. A region of a motor vehicle comprising:
a wheel housing, within which a wheel and the radiator module according to claim 1 are arranged.

8. The region according to claim 7, wherein the reinforcing assembly is designed in such a way that the wheel is moved out of the wheel housing during an accident.

9. The region according to claim 7, wherein the radiator module is arranged in front of the wheel in the direction of travel.

10. The region according to claim 7, wherein the reinforcing assembly is arranged in front of the radiator in the direction of travel.
